(19) United States
(12) Patent Application Publication
(10) Pub. No.: US 2025/0162835 A1
(43) Pub. Date: May 22, 2025

(54) DOOR HANDLE ACCESSORY, AN APPARATUS AND A SYSTEM COMPRISING THE DOOR HANDLE ACCESSORY AND THE APPARATUS

(71) Applicant: KONE Corporation, Helsinki (FI)

(72) Inventors: Mikko MATTILA, Helsinki (FI); Peter WAKIM, Moline, IL (US); Hannu NOUSU, Helsinki (FI); Tero HOTTINEN, Helsinki (FI); Paul TAYLOR, Helsinki (FI)

(73) Assignee: KONE Corporation, Helsinki (FI)

(21) Appl. No.: 19/028,444

(22) Filed: Jan. 17, 2025

Related U.S. Application Data
(63) Continuation of application No. PCT/US2022/037696, filed on Jul. 20, 2022.

(51) Int. Cl. B66B 1/46; B66B 1/34; G08C 17/02

(52) U.S. Cl. CPC B66B 1/468; B66B 1/3461; G08C 17/02; B66B 2201/101; B66B 2201/4638

(57) ABSTRACT

According to an aspect, there is provided a door handle accessory for a door handle of a door. The door handle accessory includes a memory configured to store an identifier associated with the door handle accessory; a transceiver configured to provide wireless connectivity; at least one sensor configured to provide measurements being indicative of an action applied via the door handle accessory; and a control unit connected to the memory, the transceiver and the at least one sensor, the control unit being configured to: obtain at least one measurement from the at least one sensor; obtain the identifier from the memory in response to obtaining the at least one measurement; and cause transmission of a message with the transceiver, the message comprising the identifier.

### BACKGROUND

Millions of people live in buildings that may have several floors, for example, in high rise residential condominiums and apartment buildings. When they leave their apartment and want to exit the building, they may need to, for example, call an elevator to their residential floor or use stairs which may not be practical for a building over four floors. A person leaving an apartment may walk to the elevator landing and call the elevator manually. Another possibility for calling an elevator is to use an application executed in a smartphone to remotely call the elevator before leaving the apartment or to activate, for example, a voice assistant implementation in the apartment and to request an elevator with the voice assistant. Similarly, when the person arrives in or leaves the apartment, various building entities, for example, lights and a heating, ventilation and air conditioning (HVAC) entity may have to be manually switched on/off.

There is a need for a solution that would enable an effortless control of at least one building entity.

### SUMMARY

According to a first aspect, there is provided a door handle accessory for a door handle of a door. The door handle accessory comprises a memory configured to store an identifier associated with the door handle accessory, a transceiver configured to provide wireless connectivity, at least one sensor configured to provide measurements, the measurements being indicative of an action applied via the door handle accessory, and a control unit connected to the memory, the transceiver and the at least one sensor. The control unit is configured to obtain at least one measurement from the at least one sensor, obtain the identifier from the memory in response to obtaining the at least one measurement, and cause transmission of a message with the transceiver, the message comprising the identifier.

In an implementation form of the first aspect, the at least one measurement indicates a user incoming to a space associated with the door.

In an implementation form of the first aspect, the at least one measurement indicates a user outgoing from a space associated with the door.

In an implementation form of the first aspect, the at least one sensor comprises at least one acceleration sensor.

In an implementation form of the first aspect, the at least one sensor comprises at least one pressure sensor.

In an implementation form of the first aspect, the at least one measurement comprises information indicative a pressure level, and the control unit is configured to determine whether a pressure level measured by the at least one pressure sensor exceeds a predetermined pressure level, and cause transmission of the message with the transceiver, when the pressure level exceeds the predetermined pressure level.

In an implementation form of the first aspect, the at least one measurement comprises information indicative of a pressure level, and the control unit is configured to determine whether the at least one measurement comprises a predetermined pressure level pattern, and cause transmission of the message with the transceiver, when the at least one measurement comprises the predetermined pattern.

In an implementation form of the first aspect, the control unit is configured to determine that the at least measurement fulfills a predetermined condition, and cause transmission of the message, when the at least measurement fulfills the predetermined condition.

In an implementation form of the first aspect, the control unit is configured to determine, based on the at least one measurement from the at least one sensor, that the door handle was pulled, and cause transmission of the message with the transceiver, when the door handle was pulled.

In an implementation form of the first aspect, the control unit is configured to determine, based on the at least one measurement from the at least one sensor, that the door handle was pushed, and cause transmission of the message with the transceiver, when the door handle was pushed.

In an implementation form of the first aspect, the control unit is configured to include the at least one measurement in the message.

In an implementation form of the first aspect, the control unit is configured to delay the transmission of the message with the transceiver by a time delay.

According to a second aspect, there is provided an apparatus comprising a first communication interface configured to provide wireless connectivity with at least one door handle accessory, a second communication interface configured to provide connectivity to a building system, and a controller. The controller is configured to obtain, via the first communication interface, a message comprising an identifier associated with a door handle accessory of the at least one door handle accessory, determine a command associated with the building system based on the message, and transmit, via the second communication interface, a command to the building system to control at least one building entity.

In an implementation form of the second aspect, the message comprises at least one measurement, and the controller is configured to determine that the at least measurement fulfills a predetermined condition of a plurality of predetermined conditions, and cause transmission of the command, when the at least measurement fulfills the predetermined condition, the command being associated with the predetermined condition.

In an implementation form of the second aspect, the message comprises at least one measurement, and the controller is configured to determine that the at least measurement fulfills a predetermined condition, and cause transmission of the command, when the at least measurement fulfills the predetermined condition.

In an implementation form of the second aspect, the at least one measurement comprises at least one pressure measurement measured by at least one pressure sensor of the door handle accessory.

In an implementation form of the second aspect, the at least one measurement comprises at least one acceleration measurement measured by at least one acceleration sensor of the door handle accessory.

In an implementation form of the second aspect, the controller is configured to cause transmission of the at least one measurement for further analysis, and receive a command determined based on the analysis.

In an implementation form of the second aspect, the command comprises an elevator call to park the elevator to a specific location in an elevator shaft.

In an implementation form of the second aspect, the command comprises an elevator call to a floor associated with the door handle accessory.

In an implementation form of the second aspect, the command comprises a command to control at least one building entity in a space associated with the door handle accessory.

In an implementation form of the second aspect, the at least one building entity comprises at least one of a light and a heating, ventilation and air conditioning, HVAC, entity.

According to a third aspect, there is provided a system comprising at least one door handle accessory of the first aspect and an apparatus of the second aspect.

According to a fourth aspect, there is provided a method comprising obtaining, by a control unit, at least one measurement from at least one sensor comprised in a door handle accessory, the at least one measurement being indicative of an action applied via the door handle accessory; obtaining, by the control unit, an identifier associated with the door handle accessory from a memory comprised in the door handle accessory in response to obtaining the at least one measurement; and causing, by the control unit, transmission of a message with a transceiver comprised in the door handle accessory, the message comprising the identifier.

According to a fifth aspect, there is provided a method comprising obtaining, by a controller via a first communication interface, a message comprising an identifier associated with a door handle accessory of at least one door handle accessory, determining, by the controller, a command associated with a building system based on the message, and transmitting, by the controller via a second communication interface, a command to the building system to control at least one building entity.

According to a sixth aspect, there is provided a computer program comprising instructions which, when the program is executed by a controller, cause the controller to carry out the method of the fourth aspect.

According to a seventh aspect, there is provided a computer program comprising instructions which, when the program is executed by a controller, cause the controller to carry out the method of the fifth aspect.

According to an eighth aspect, there is provided a computer-readable medium comprising a computer program comprising instructions which, when the program is executed by a controller, cause the controller to carry out the method of the fourth aspect.

According to a ninth aspect, there is provided a computer-readable medium comprising a computer program comprising instructions which, when the program is executed by a controller, cause the controller to carry out the method of the fifth aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a block diagram of an apparatus according to an example embodiment.

FIG. 2A illustrates a door handle and a door handle accessory according to an example embodiment.

FIG. 2B illustrates a door knob and a door knob accessory according to an example embodiment.

FIG. 3 illustrates a block diagram of a system according to an example embodiment.

FIG. 4 illustrates a flow diagram of a method according to an example embodiment.

FIG. 5 illustrates a flow diagram of a method according to another example embodiment.

### DETAILED DESCRIPTION

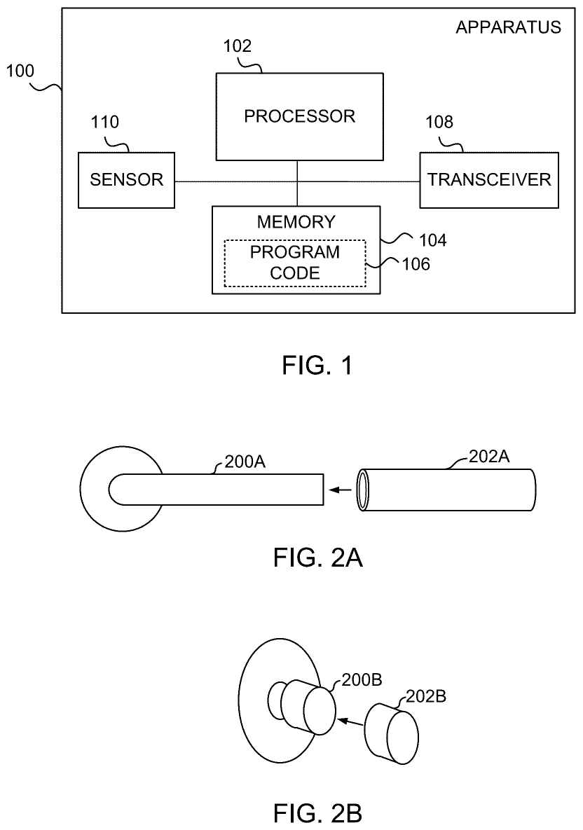

FIG. 1 illustrates a block diagram of an apparatus 100 according to an example embodiment.

The apparatus 100 comprises one or more processors 102, one or more memories 104 that comprise computer program code 106, a transceiver 108 and at least one sensor 110. Although the apparatus 100 is depicted to include only one processor 102, the apparatus 100 may include more than one processor. In an example embodiment, the memory 104 is capable of storing instructions, such as an operating system and/or various applications, and a unique identifier that be used to identify a door handle accessory.

Furthermore, the processor 102 is capable of executing the stored instructions. In an example embodiment, the processor 102 may be embodied as a multi-core processor, a single core processor, or a combination of one or more multi-core processors and one or more single core processors. For example, the processor 102 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 102 may be configured to execute hard-coded functionality. In an example embodiment, the processor 102 is embodied as an executor of software instructions, wherein the instructions may specifically configure the processor 102 to perform the algorithms and/or operations described herein when the instructions are executed.

The memory 104 may be embodied as one or more volatile memory devices, one or more non-volatile memory devices, and/or a combination of one or more volatile memory devices and non-volatile memory devices. For example, the memory 104 may be embodied as semiconductor memories (such as mask ROM, PROM (programmable ROM), EPROM (erasable PROM), flash ROM, RAM (random access memory), etc.).

In an embodiment, the at least one memory 104 may store program instructions 106 that, when executed by the at least one processor 102, cause the apparatus 100 to perform the functionality of the various embodiments discussed herein. Further, in an embodiment, at least one of the processor 102 and the memory 104 may constitute means for implementing the discussed functionality.

The transceiver 108 may be configured to provide wireless connectivity using, for example, Bluetooth, Zigbee, Wi-Fi or any other wireless communication technique or standard.

The at least one sensor 110 may comprise at least one of a pressure sensor (for example, a strain gauge) and an acceleration sensor or several of these sensors, or at least one pressure sensor and at least one acceleration sensor. Further, although not illustrated in FIG. 1, the apparatus 100 may comprise a battery or a chargeable battery to provide operating power for the apparatus 100.

FIG. 2A illustrates a door handle 200A and a door handle accessory 202A according to an example embodiment, and FIG. 2B illustrates a door knob 200B and a door knob accessory 202B according to an example embodiment. Thus, when speaking about a “door handle”, it may refer, for example, to a door handle type illustrated in FIG. 2A or to a door knob type illustrated in FIG. 2B or to any other type of a door handle used with doors. The door handle accessory 202A, 202B may comprise the apparatus 100 discussed in more detail above in relation to FIG. 1. The apparatus 100 may be integrated into the door handle accessory 202A, 202B such that it is invisible to a user using the door handle 200A, 200B. In other embodiments, the door handle accessory 202A, 202B may take any appropriate physical form configured to fit on the door handle 200A, 200B or it may be otherwise attached on the door handle 200A, 200B. As illustrated in FIGS. 2A and 2B, the accessory may take a form of a sleeve to be placed on the door handle 200A or the door knob 200B.

The door handle accessory 202A, 202B comprises the memory 104 configured to store an identifier associated with the door handle accessory 202A, 202B. The identifier may uniquely identify the door handle accessory 202A, 202B among other door handle accessories. The door handle accessory 202A, 202B further comprises the transceiver 108 configured to provide wireless connectivity using, for example, Bluetooth, Zigbee, Wi-Fi or any other wireless communication standard. The door handle accessory 202A, 202B further comprises the at least one sensor 110 configured to provide measurements being indicative of an action applied via the door handle accessory 202A, 202B. The action may refer, for example, to pressure applied on the door handle accessory 202A, 202B by a user, when the user touches the door handle accessory 202A, 202B. In another example embodiment, the action may refer, for example, to movement of the door caused by the user touching the door handle accessory 202A, 202B, the movement being identified by the at least one sensor 110. For example, the measurements may indicate movement of a door comprising the door handle accessory 202A, 202B, when a user touches the door or the door handle accessory 202A, 202B. In an example embodiment, the measurements may also indicate the side of the door from which the movement was initiated. The at least one sensor 110 may comprise, for example, at least one of a pressure sensor (for example, a strain gauge) and an acceleration sensor. The door handle 200A, 200B may be arranged in a door, for example, a front door or an interior door, leading to a space, for example, a room or an apartment of a person.

The door handle accessory 202A, 202B further comprises a control unit 102 connected to the memory 104, the transceiver 108 and the at least one sensor 110, and the control unit 102 being configured to obtain at least one measurement from the at least one sensor 110, obtain the identifier from the memory 104 in response to obtaining the at least one measurement, and cause transmission of a message with the transceiver 108, the message comprising the identifier.

As discussed above and illustrated in FIG. 2A, the door handle accessory 202A, 202B may be manufactured, for example, as a hollow cylindrical object having one closed end, and the necessary electronics may be integrated into the accessory. The door handle accessory 202A, 202B may be attached to the door handle 200A, 200B using any appropriate attaching means, for example, a glue etc. The material of the door handle accessory 202A, 202B may be plastic, rubber, fabric or any other appropriate material from which an accessory can be manufactured.

A measurement or measurements from the at least one sensor 110, for example, at least one pressure sensor and/or at least one acceleration sensor, may be used to determine whether a user is pulling or pushing the door handle 200A, 200B. In an example embodiment, separate sensors may be arranged on different sides of the door handle accessory 202A, 202B. For example, when pushing the door handle 200A, 200B, pressure is applied to it differently and in different sections than when pulling the door handle 200A, 200B. For example, when a door opens towards inside of a room or apartment, and the door handle accessory 202A, 202B is attached to a door handle inside the room or apartment, pulling the door handle 200A, 200B may indicate that the user is leaving the room or apartment. This can be used as a trigger to transmit the identifier stored in the memory 104. The control unit 102 is configured to obtain the measurement or measurements from the at least one sensor 110, obtain the identifier from the memory 104 in response to obtaining the at least one measurement, and cause transmission of a message with the transceiver 108, the message comprising the obtained identifier. The recipient of this transmission is then able to determine a command and send it to a building system to control at least one building entity. In an example embodiment, the command may be an elevator call to a floor associated with the door handle accessory 202A, 202B, an elevator call to park the elevator to a floor or to a specific location in an elevator shaft, or a command to switch off at least one of a light and a heating, ventilation and air conditioning, HVAC, entity. In another example embodiment, the door handle accessory 202A, 202B may be attached to the door handle 200A, 200B on the other side of the door, i.e. on the side facing a corridor. Again, pulling the door handle 200A, 200B may indicate that the user is leaving the room or apartment. In another example embodiment, the door of the room or apartment may open towards the corridor. In this case, when the door is opened from the inside of the room or apartment, the door handle may be determined to be pushed, and the message may be transmitted in response to pushing the door handle 200A, 200B.

In an example embodiment, the at least one measurement received by the control unit 102 may comprise information indicative of a pressure level. In response to the signal, the control unit 102 may be configured to determine whether a pressure level measured by the at least one pressure sensor exceeds a predetermined pressure level, and cause transmission of the message with the transceiver 108, when the pressure level exceeds the predetermined pressure level. The pressure level can thus be used to separate, for example, an instance when a leaving user does not wish to trigger the command to the building system to control at least one building entity from an instance when the user wishes to trigger the command to the building system to control the at least one building entity.

In an example embodiment, a time delay for the transmission may have been set into the memory 104. The control unit 102 may be configured to delay the transmission of the message with the transceiver 108 by the time delay. In case of triggering an elevator call, the time delay may be set to ensure the elevator does not arrive too quickly. Thus, the time delay may take into account the walking distance from the door to the elevator.

In an example embodiment, the at least one measurement may comprise information indicative of a pressure level, and the control unit may be configured to determine whether the at least one measurement comprises a predetermined pressure level pattern, and cause transmission of the message with the transceiver 108, when the at least one measurement comprises the predetermined pattern. For example, a certain number of squeezes of the door handle accessory 202A, 202B or a certain number of taps on the door handle accessory 202A, 202B may be used as a trigger to send the message. Further, instead of using a predetermined pressure level pattern, any predetermined fulfilled condition associated with the at least one measurement may be used as a trigger for transmitting the message.

In an example embodiment, the at least one measurement may comprise one or more measurements from at least one pressure sensor and one or more measurements from at least one acceleration sensor. The control unit 102 may be configured to determine whether the at least one measurement fulfills a predetermined condition, for example, a predetermined pressure level or pattern and a predetermined acceleration level or pattern. If the predetermined condition is fulfilled, the control unit 102 may be configured to cause transmission of the message with the transceiver 108.

In an example embodiment, the control unit 102 may be configured to include the at least one measurement in the message. This may be used, for example, when the recipient of the message is configured to analyze the measurements and determine whether an action is needed based on the analysis. Further, in an example embodiment, the at least one measurement may comprise one or more measurements from at least one pressure sensor and one or more measurements from at least one acceleration sensor.

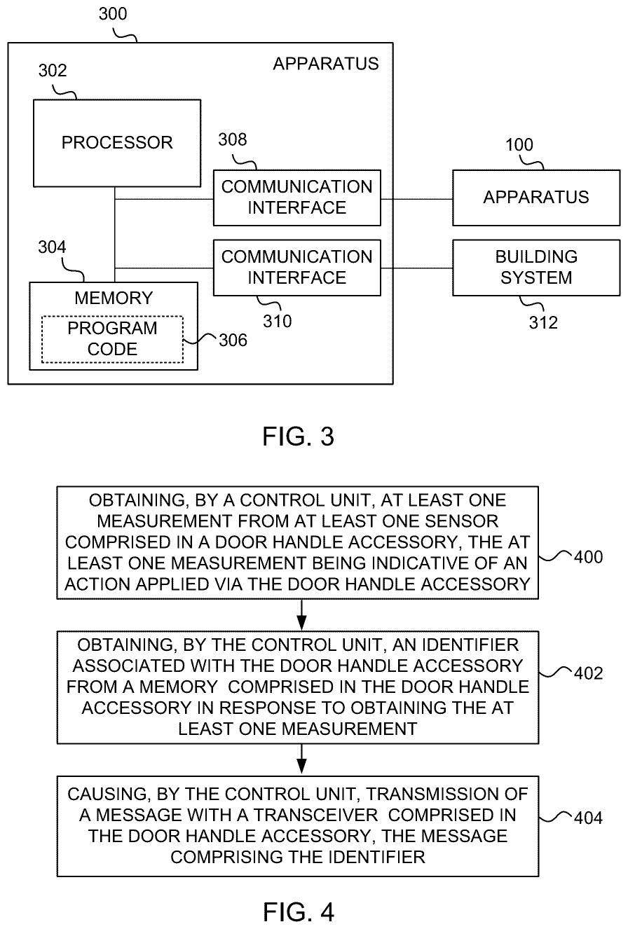

FIG. 3 illustrates a block diagram of a system according to an example embodiment. The system comprises an apparatus 300, the apparatus 100 discussed in more detail above in relation to FIG. 1 and a building system 312.

The apparatus 300 may refer, for example, to a communication node, server or hub that may be located in every floor. In another example embodiment, the communication hub may be arranged in a central location in the building. The communication hub may comprise similar elements and components that the apparatus 100 illustrated in FIG. 1, and thus reference is made to the description of FIG. 1 with respect to its elements and their functionality. However, instead of having only one communication interface, the communication hub may comprise two communication interfaces 308, 310. The first communication interface 308 may be configured to provide wireless connectivity with the apparatus 100 arranged in the at least one door handle accessory 202A, 202B. The second communication interface 310 may be configured to provide connectivity to the building system 312. In an example embodiment, the second communication interface 312 may be configured to communicate via a wired connection, for example, an Ethernet link. In another example embodiment, the second communication interface 312 may be configured to communicate via a wireless connection, for example, a Wi-Fi connection. In an example embodiment, the first communication interface 308 and the second communication interface 310 may be provided by a single communication interface.

As discussed already above, the apparatus 100 is configured to cause transmission of the message comprising the identifier to the apparatus 300. In response to receiving the message, the apparatus 300 may be configured to determine a command associated with the building system based on the message and transmit, via the second communication interface 310, the command to the building system 312 to control at least one building entity. In an example embodiment, the command may comprise an elevator call to a floor associated with the door handle accessory 202A, 202B or an elevator call to park the elevator to a specific location in an elevator shaft, for example, to a specific floor. In another example embodiment, the command may comprise a command to control at least one building entity in a space (i.e. the room or apartment) associated with the door handle accessory 202A, 202B. The at least one building entity may refer, for example, to at least one of a light and a heating, ventilation and air conditioning, HVAC, entity.

In an example embodiment, the message may comprise at least one measurement measured with the at least one sensor 110 of the door handle accessory 202A, 202B. The controller 302 may be configured to analyze the at least one measurement to determine whether the at least measurement fulfills a predetermined condition of a plurality of predetermined conditions. For example, the plurality of predetermined conditions may have been predefined in the memory 304, and the controller 302 then compares the at least one measurement or some calculated variable(s) calculated based on them to the predetermined conditions stored in the memory 304. Each predetermined condition may have an associated command. Thus, depending on which predetermined condition is fulfilled, a different command may be issued to the building system 312. In another example embodiment, the memory 304 may store only one predetermined condition and a command associated with it, and the controller 302 is configured to determine whether the at least one measurement fulfills this condition.

In an example embodiment, the message may comprise one or more measurements from at least one pressure sensor and one or more measurements from at least one acceleration sensor. The controller 302 may be configured to analyze the measurements and determine based on the analysis whether a command is to be issued. The analysis may involve, for example, machine learning that analyses the measurement data in the message and earlier received measurement data.

In another example embodiment, the controller 302 may be configured to send the at least one measurement to another entity, for example, to a cloud-based entity, for further analysis, and then receive a result (for example, a command) from the entity. This may enable a solution in which the cloud-based entity also gathers historical data about the measurements and their analysis, and may be able to improve the reliability of the analysis of the measurements based on the historical data.

In an example embodiment, the at least one measurement may comprise at least one pressure measurement measured by the at least one pressure sensor 110 of the door handle accessory 202A, 202B and/or at least one acceleration measurement measured by at least one acceleration sensor 110 of the door handle accessory 202A, 202B.

FIG. 4 illustrates a flow diagram of a method according to an example embodiment. The method may be performed by the apparatus 100 illustrated in FIG. 1.

At 400 at least one measurement from at least one sensor comprised in a door handle accessory, the at least one measurement being indicative of an action applied via a door handle accessory, may be obtained by the control unit 102.

At 402 an identifier associated with the door handle accessory 202A, 202B may be obtained by the control unit 102 from the memory 104 comprised in the door handle accessory 202A, 202B in response to obtaining the at least one measurement.

At 404 transmission of a message may be caused by the control unit 102 with the transceiver 108 comprised in the door handle accessory 202A, 202B, the message comprising the identifier.

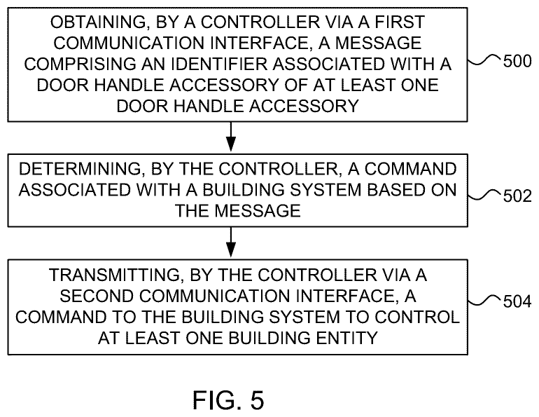

FIG. 5 illustrates a flow diagram of a method according to an example embodiment. The method may be performed by the apparatus 300 illustrated in FIG. 3.

At 500 a message comprising an identifier associated with a door handle accessory of the at least one door handle accessory 202A, 202B may be obtained by the controller 302 via the first communication interface 308.

At 502 a command associated with the building system may be determined based on the message. If the message includes at least one measurement from at least one sensor 110 of the door handle accessory 202A, 202B, the determination may involve, for example, analysis of the at least one measurement to determine the command.

At 504 the command may be transmitted by the controller 302 via the second communication interface 310 to the building system 312 to control at least one building entity.

At least one of the examples and embodiments disclosed above may enable a solution in which no additional user action is required to trigger the message, for example, an elevator call, thus providing an automatic experience to the user. Further, as the apparatus can be provided as an accessory and may be battery powered and uses low power wireless communication, it can be retrofitted to any door and to any existing building or elevator control. Further, the accessory does not require any additional wiring to power supply or to enable communication inside the room or apartment.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A door handle accessory for a door handle of a door, the door handle accessory comprising:
a memory configured to store an identifier associated with the door handle accessory;
a transceiver configured to provide wireless connectivity;
at least one sensor configured to provide measurements being indicative of an action applied via the door handle accessory; and
a control unit connected to the memory, the transceiver and the at least one sensor, the control unit being configured to:
obtain at least one measurement from the at least one sensor;
obtain the identifier from the memory in response to obtaining the at least one measurement; and
cause transmission of a message with the transceiver, the message comprising the identifier.

2. The door handle accessory of claim 1, wherein the at least one measurement indicates a user incoming to a space associated with the door.

3. The door handle accessory of claim 1, wherein the at least one measurement indicates a user outgoing from a space associated with the door.

4. The door handle accessory of claim 1, wherein the at least one sensor comprises at least one acceleration sensor.

5. The door handle accessory of claim 1, wherein the at least one sensor comprises at least one pressure sensor.

6. The door handle accessory of claim 5, wherein the at least one measurement comprises information indicative a pressure level, and the control unit is configured to:
determine whether a pressure level measured by the at least one pressure sensor exceeds a predetermined pressure level; and
cause transmission of the message with the transceiver, when the pressure level exceeds the predetermined pressure level.

7. The door handle accessory of claim 5, wherein the at least one measurement comprises information indicative of a pressure level, and the control unit is configured to:
determine whether the at least one measurement comprises a predetermined pressure level pattern; and
cause transmission of the message with the transceiver, when the at least one measurement comprises the predetermined pattern.

8. The door handle accessory of claim 1, wherein the control unit is configured to:
determine that the at least measurement fulfills a predetermined condition; and
cause transmission of the message, when the at least measurement fulfills the predetermined condition.

9. The door handle accessory of claim 1, wherein the control unit is configured to:
determine, based on the at least one measurement from the at least one sensor, that the door handle was pulled; and
cause transmission of the message with the transceiver, when the door handle was pulled.

10. The door handle accessory of claim 1, wherein the control unit is configured to:
determine, based on the at least one measurement from the at least one sensor, that the door handle was pushed; and
cause transmission of the message with the transceiver, when the door handle was pushed.

11. The door handle accessory of claim 1, wherein the control unit is configured to:
include the at least one measurement in the message.

12. The door handle accessory of claim 1, wherein the control unit is configured to:
delay the transmission of the message with the transceiver by a time delay.

13. An apparatus comprising:
a first communication interface configured to provide wireless connectivity with at least one door handle accessory;
a second communication interface configured to provide connectivity to a building system; and
a controller configured to:
obtain, via the first communication interface, a message comprising an identifier associated with a door handle accessory of the at least one door handle accessory; and
determine a command associated with the building system based on the message; and
transmit, via the second communication interface, the command to the building system to control at least one building entity.

14. The apparatus of claim 13, wherein the message comprises at least one measurement, and the controller is configured to:
determine that the at least measurement fulfills a predetermined condition of a plurality of predetermined conditions; and
cause transmission of the command, when the at least measurement fulfills the predetermined condition, the command being associated with the predetermined condition.

15. The apparatus of claim 13, wherein the message comprises at least one measurement, and the controller is configured to:
determine that the at least measurement fulfills a predetermined condition; and
cause transmission of the command, when the at least measurement fulfills the predetermined condition.

16. The apparatus of claim 14, wherein the at least one measurement comprises at least one pressure measurement measured by at least one pressure sensor of the door handle accessory.

17. The apparatus of claim 14, wherein the at least one measurement comprises at least one acceleration measurement measured by at least one acceleration sensor of the door handle accessory.

18. The apparatus of claim 13, wherein the controller is configured to:
cause transmission of the at least one measurement for further analysis; and
receive a command determined based on the analysis.

19. The apparatus of claim 13, wherein the command comprises an elevator call to park the elevator to a specific location in an elevator shaft.

20. The apparatus of claim 13, wherein the command comprises an elevator call to a floor associated with the door handle accessory.

21. The apparatus of claim 13, wherein the command comprises a command to control at least one building entity in a space associated with the door handle accessory.

22. The apparatus of claim 21, wherein the at least one building entity comprises at least one of a light and a heating, ventilation and air conditioning, HVAC, entity.

23. A system comprising:
at least one door handle accessory comprising:
a memory configured to store an identifier associated with the door handle accessory;
a transceiver configured to provide wireless connectivity;
at least one sensor configured to provide measurements being indicative of an action applied via the door handle accessory; and
a control unit connected to the memory, the transceiver and the at least one sensor, the control unit being configured to:
obtain at least one measurement from the at least one sensor;
obtain the identifier from the memory in response to obtaining the at least one measurement; and
cause transmission of a message with the transceiver, the message comprising the identifier; and
the apparatus of claim 13.

24. A method comprising:
obtaining, by a control unit, at least one measurement from at least one sensor comprised in a door handle accessory, the at least one measurement being indicative of an action applied via the door handle accessory;
obtaining, by the control unit, an identifier associated with the door handle accessory from a memory comprised in the door handle accessory in response to obtaining the at least one measurement; and
causing, by the control unit, transmission of a message with a transceiver comprised in the door handle accessory, the message comprising the identifier.

25. A method comprising:
obtain, by a controller via a first communication interface, a message comprising an identifier associated with a door handle accessory of at least one door handle accessory; and
determine, by the controller, a command associated with a building system based on the message; and
transmit, by the controller via a second communication interface, a command to the building system to control at least one building entity.

26. A computer program comprising instructions which, when the program is executed by a control unit, cause the control unit to carry out the method of claim 24.

27. A computer program comprising instructions which, when the program is executed by a controller, cause the controller to carry out the method of claim 25.

28. A computer-readable medium comprising a computer program comprising instructions which, when the program is executed by a control unit, cause the control unit to carry out the method of claim 24.

29. A computer-readable medium comprising a computer program comprising instructions which, when the program is executed by a controller, cause the controller to carry out the method of claim 25.
